(19) United States
(12) Patent Application Publication
(10) Pub. No.: US 2024/0383363 A1
(43) Pub. Date: Nov. 21, 2024

(54) ELECTRIC VEHICLE CHARGING SYSTEM WITH DISTRIBUTED CHARGING

(71) Applicant: EVJAM LLC, Minneapolis, MN (US)

(72) Inventors: Steven DICKE, Minneapolis, MN (US); Gregg KROMREY, Hudson, WI (US)

(73) Assignee: EVJAM LLC, Minneapolis, MN (US)

(21) Appl. No.: 18/668,445

(22) Filed: May 20, 2024

Related U.S. Application Data
(60) Provisional application No. 63/467,911, filed on May 19, 2023.

(51) Int. Cl. B60L 53/66; B60L 53/16; B60L 53/31; B60L 53/67; G06Q 50/06; H02J 7/00

(52) U.S. Cl. CPC B60L 53/665; B60L 53/16; B60L 53/31; B60L 53/67; G06Q 50/06; H02J 7/0042

(57) ABSTRACT

One or more examples provide an electric vehicle or a device for use with an electric vehicle, including a vehicle parking system and an electric vehicle charging system with distributed charging, and method of distributed charging.

### CROSS REFERENCE TO RELATED APPLICATION

This Non-Provisional Patent Application claims the benefit of the filing date of U.S. Provisional Patent Application Ser. No. 63/467,911, filed May 19, 2023, which is herein incorporated by reference.

### TECHNICAL FIELD

The present disclosure relates generally to examples of electric vehicles and to devices for use with an electric vehicle, including electric vehicle batteries and electric vehicle charging systems and devices.

### BACKGROUND

Electric vehicles and electric vehicle devices provide quiet, clean, and efficient powertrains for moving from place to place or for getting work done.

Problems exist when there is a need to charge electric vehicles in locations typically used for parking.

For these and other reasons, there is a need for the present invention.

### SUMMARY

The present disclosure provides one or more examples of an electric vehicle and systems and/or devices for use with an electric vehicle. In one or more examples, the system is an electric vehicle charging system and/or charging device.

Additional and/or alternative features and aspects of examples of the present technology will become apparent from the following description and the accompanying drawings.

### BRIEF DESCRIPTION OF THE DRAWINGS

The Figures generally illustrate one or more examples of an electric vehicle and/or devices for use with an electric vehicle such as electric vehicle batteries or electric vehicle charging systems and devices, including an electric vehicle charging system with distributed charging.

FIG. 1 is a diagram generally illustrating a charging system, according to examples of the present disclosure.

FIG. 2 is a diagram illustrating a charging system, according to examples of the present disclosure.

FIG. 3 is a diagram illustrating one application of a charging system with distributed charging, according to examples of the present disclosure.

FIG. 4 is a diagram generally illustrating a master charging station, according to examples of the present disclosure.

FIG. 5 is a diagram illustrating power feed through a master charging station, according to examples of the present disclosure.

FIG. 6 is a diagram illustrating a power feed system for a charging system that includes multiple charging stations, according to examples of the present disclosure.

FIG. 7 is a diagram illustrating a charging post suitable for use with a charging system, according to examples of the present disclosure.

FIG. 8 is a diagram illustrating a charging system charging cable, according to examples of the present disclosure.

FIG. 9A is a diagram illustrating an adapter for use with a charging cable, according to examples of the present disclosure.

FIGS. 9B, 9C are diagrams illustrating a charging post including a charging outlet, according to examples of the present disclosure.

FIGS. 10A-10D are diagrams illustrating a charging system with distributed charging load balancing examples, according to examples of the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense. It is to be understood that features of the various examples described herein may be combined, in part or whole, with each other, unless specifically noted otherwise.

Electric vehicles (EVs), such as automobiles (e.g., cars and trucks), autonomous vehicles, snowmobiles, personal watercraft (PWC), all-terrain vehicles (ATVs), side-by-side vehicles (SSVs), and electric bikes, for example, offer a quiet, clean, and more environmentally friendly option to gas-powered vehicles. Electric vehicles have electric powertrains which typically include a battery system, one or more electrical motors, each with a corresponding electronic power inverter (sometimes referred to as a motor controller), and various auxiliary systems (e.g., cooling systems).

Electric Vehicle Charging System with Distributed Charging

The present disclosure provides a vehicle parking system with distributed charging. In one application, the system is suitable for use in a high volume charging/parking environment. The present charging system is suitable for use in large cities where it may be desired to both park and/or charge a vehicle using the same parking location.

The electric vehicle charging system includes a master parking/charging station having charging distribution feeds to multiple charging posts. Each charging post includes a charging outlet suitable for charging an electric vehicle. A charging cable is used for charge coupling (i.e., electric coupling) the charging outlet to an electric vehicle requesting a charge.

In one example, the electric vehicle charging system is part of a parking system. Some or all of the parking spaces can be used for vehicle parking (electric or non-electric), electric vehicle charging, and/or both. A master charging station including a master parking/charging controller can be used as part of a parking system and/or charging system. The same master controller is used for both charging and parking. The master controller may or may not be located in the master parking/charging station. The master station can accept local or direct payment for both parking and electric vehicle charging.

Operation of the electric vehicle charging system may be done either local to the charging vehicle or remotely via a computer, ev control system, charging station control system, or a user control application located on a smart device (e.g., via a phone).

An Electric Vehicle Charging System with Distributed Charging can include a combination of one or more of the following features:

Electric Vehicle Charging System. EV charging system with distributed charging. Charging system is suitable for use in large urban areas. In one example, the charging system includes a master charging station coupled to one or more distributed charging posts for charging an electric vehicle parked at that location.

Master Station. Receives incoming charging power feed and provides a distributed power feed to multiple charging posts. Master charging station can include a parking and/or charging pay station, smart system, voltage converter, load balancing, and other smart charging components. Can interface with a charging/parking control system as part of a large electric vehicle charging network. Can communicate with a user interface to coordinate/specify/bill for charging and/or parking for a vehicle located in a charging space. Can utilize the pay station locally or pay via a user interface.

Voltage converter allows a user to switch to a desired charging voltage and/or AC or DC charging.

Dynamic Charging. Load balancing can be utilized where the charging load is actively checked and balanced for optimal use of charging capacity.

Can operate as both a master charging station and as a master parking station. A master charging/parking controller can be located at the master station or remote from the master station. The master station can accept local or direct payment for both parking and/or electric vehicle charging.

Charging Post. Located in close proximity to one or more associated charging spaces. Can be addressable/numbered, and tracked via a global system (e.g., a GPS system). Includes a charging outlet for coupling to an electric vehicle requesting a charge. Very simple setup safe for urban use. May include a charging outlet locking mechanism.

Charging Cord. Includes a plug (e.g., a lockable plug) system for coupling to the charging outlet. Includes a charging plug for coupling the charging system to an electric vehicle charging port. May include an adapter between the charging outlet plug and the charging outlet to aid in adapting to specific charging configurations. Charging Cable Plugs. The charging cable can be portable and configured for use with a specific charging vehicle. In one example, the charging cable includes a first plug for coupling to the charging interface unit and a second plug for coupling to the charging port of an electric vehicle. Quick Couple Plug. In one example, the first plug is suitable for quick coupling to the charging post charging outlet.

Dynamic Charging/Load Management/Balancing System. Can include a load management/balancing system to optimize vehicle charging. Load balancing system factors can include: number of vehicles requesting a charge, type of vehicle, desired charging speed, desired charging type, charging supply power available, etc.

One or more examples and features of the charging system are detailed herein and illustrated in the Figures.

In one example, the charging system is a vehicle charging system with distributed charging. The vehicle charging system includes a master charging station having a power distribution unit including a first charging distribution feed. A first charging post is located separate from the master charging station. The first charging post includes a first charging outlet coupled to the first charging distribution feed for charge connecting to an electric vehicle. In one or more examples, a user interface controls the flow of charging power between the master charging station and the first charging outlet.

In another example, the charging system is a vehicle charging system with distributed charging. The vehicle charging system includes a master charging station having an input charging power feed and a distribution unit. The distribution unit receives the input charging power feed and provides multiple charging distribution feed outputs, including a first charging distribution feed and a second charging distribution feed.

A first charging post is spaced from the master charging station and coupled to the first charging distribution feed. The first charging post includes a first charging outlet coupled to the charging distribution feed. A second charging post is spaced from the master charging station and coupled to the second charging distribution feed. The second charging post includes a second charging outlet coupled to the second charging distribution feed.

In another example, multiple charging posts are provided, where each charging post is located near a vehicle charging space. Each charging post is electrically coupled to a master charging station, and spaced from the master charging station at a location near a charging space. Each charging post only includes a distribution feed routed therethrough and a charging outlet. Each charging outlet is controlled and the distribution feed is metered at the master charging station.

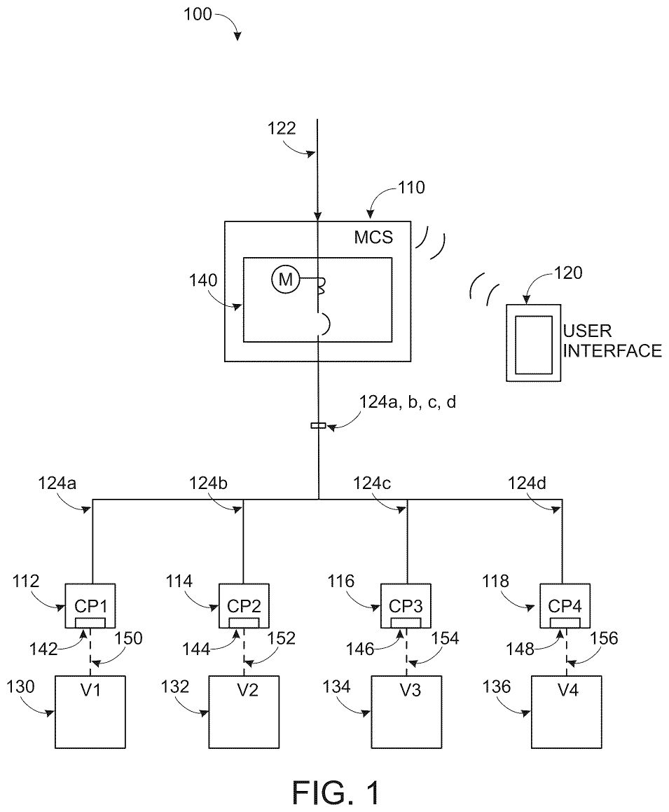

FIG. 1 is a diagram generally illustrating a charging system generally at 100, according to examples of the present disclosure. The charging system 100 is an electric vehicle charging system with distributed charging. The charging system 100 includes a master charging station 110, a charging post 112, a charging post 114, a charging post 116, a charging post 118, and a user interface 120. The master charging station 110 receives an input charging power feed 122 and provides individual controlled distribution feeds 124 (i.e., 124a, 124b, 124c, 124d) to each of the respective charging posts 112, 114, 116, 118. For simplicity, in FIG. 1 the individual charging distribution feeds 124 between the master charging station 110 and the charging posts 112, 114, 116, 118 are generally illustrated as a solid line. Each charging post 112, 114, 116, 118 are located near a vehicle parking space 130, 132, 134, 138 that can be used as both a vehicle charging location and a vehicle parking location.

The master charging system 110 includes power distribution unit 140 that outputs a first charging distribution feed 124a, a second charging distribution feed 124b, a third charging distribution feed 124c, and a fourth charging distribution feed 124d.

In examples, the first charging post 112 is located separate from the master charging station 110, near vehicle parking space 130. The first charging distribution feed 124a is routed to the first charging post 112. The first charging post 112 includes a first charging outlet 142. The first charging outlet 142 is electrically coupled to the first charging distribution feed 124a, and can be coupled to a vehicle requesting a charge that is located in the vehicle parking space 130. In one example, the first charging outlet 142 is electrically coupled to vehicle V1 illustrated, using a charging cable 150.

The second charging post 114 is located separate from the master charging station 110, near vehicle parking space 132. The second charging distribution feed 124b is routed to the second charging post 114. The second charging post 114 includes a second charging outlet 144. The second charging outlet 144 is electrically coupled to the second charging distribution feed 124b, and can be electrically coupled to a vehicle requesting a charge that is located in the vehicle parking space 132. In one example, the second charging outlet 144 is electrically coupled to vehicle V2 illustrated, using a charging cable 152.

The third charging post 116 is located separate from the master charging station 110, near vehicle parking space 134. The third charging distribution feed 124c is routed to the third charging post 116. The third charging post 116 includes a third charging outlet 146. The third charging outlet 146 is electrically coupled to the third charging distribution feed 124c, and can be coupled to a vehicle requesting a charge that is located in the vehicle parking space 134. In one example, the third charging outlet 146 is electrically coupled to vehicle V3 illustrated, using a charging cable 154.

The fourth charging post 118 is located separate from the master charging station 110, near vehicle parking space 136. The fourth charging distribution feed 124d is routed to the fourth charging post 118. The fourth charging post 118 includes a fourth charging outlet 148. The fourth charging outlet 148 is electrically coupled to the fourth charging distribution feed 124d, and can be coupled to a vehicle requesting a charge that is located in the vehicle parking space 136. In one example, the fourth charging outlet 148 is electrically coupled to vehicle V1 illustrated, using a charging cable 156.

Detailed examples of charging posts and charging cables suitable for use with the present charging system, including charging posts 112, 114, 116, 118 and corresponding charging cables 150, 152, 154, 156 are illustrated in detail later in this specification.

A user interface 158 is provided. The user interface 58 controls the flow of charging power between the mast charging station 110 and the charging outlets, illustrated as charging outlets 142, 144, 146, 148. The user interface 158 can be located separate from the master charging station 110. For example, the user interface 158 can be resident on a phone, an electric vehicle graphical user interface (GUI), tablet, computer, or similar device. The user interface 158 communicates with the master charging station 110. In one example, the user interface 158 communicates wirelessly with the master charging station 110. Alternatively or additionally, a user interface is located at the master charging station.

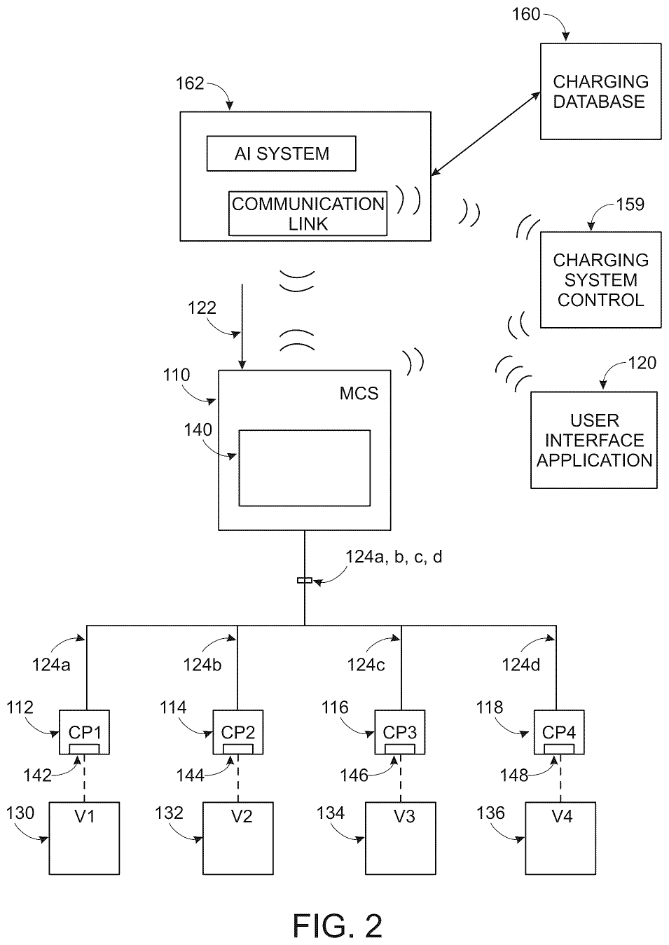

FIG. 2 is a diagram illustrating a charging system 200, according to examples of the present disclosure. Charging system 200 is an electric vehicle charging system with distributed charging, and is similar to charging system 100 previously detailed herein where like components have like element numbers.

Charging system 200 includes master charging station 110 that communicates with one or more smart charging systems to aid in optimizing charging of vehicles. In one example, master charging station 110 or user interface 120 communicate with one or more charging databases 160. In one example, charging database 160 includes information for a vehicle requesting a charge. The information may be based on a number of factors, including time of day, outside temperature, and vehicle model charging data. Additionally, each specific electric vehicle may upload stored charging optimization data to the charging database. During a charging operation, the master charging station 110 or user interface 120 can retrieve charging optimization data for the vehicle requesting a charge, and use it to determine an optimized charging of the vehicle.

In one example, artificial intelligence engine 162 is used to obtain charging optimization information. In one operation, the artificial intelligence engine 162 is queried via master charging station 110 or user interface 120. Artificial intelligence system 162 provides charging optimization information to the master charging station 110 for the vehicle requesting a charge. In another example, the artificial intelligence system 162 communicates with charging database 160 to aid in determining the charging optimization data to transfer to charging station 110. In one example, artificial intelligence system 162 is a generative artificial intelligence system. Upon starting or completion of charging a vehicle, updated charging optimization data is uploaded to the charging database via the artificial intelligence system for updated storage of charging optimization data specific to a vehicle requesting a charge.

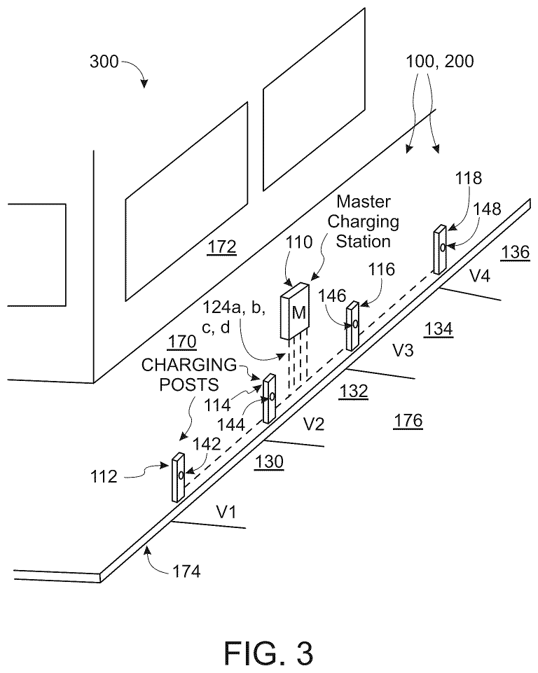

FIG. 3 is a diagram illustrating one application of charging system 100,200 with distributed charging, according to examples of the present disclosure. Charging system 100 is illustrated as an example. The charging system 100 is located in an urban downtown area, in a location similar to conventional urban parking. In other examples, the charging system 100 is part of a charging/parking facility or a parking lot charging facility. In one example, the charging system 100 is located on a sidewalk 170 near a building 172. The master charging station 110 is located on the sidewalk 170. The charging posts are located near curb 174, adjacent street 176, and immediately adjacent vehicle parking spaces.

With charging system 100, typical vehicle urban parking spaces can also be used as electric vehicle charging spaces. In one example illustrated, charging post 112 is located at curb 174 immediately adjacent parking space 130. Charging post 114 is located at curb 174 immediately adjacent parking space 132. Charging post 116 is located at curb 174 immediately adjacent parking space 134. Charging post 118 is located at curb 174 immediately adjacent parking space 136. Distribution feeds 124a,b,c,d are routed below sidewalk 170 from master charging station 110 to the corresponding charging posts 114, 116, 118, 120.

Spaces 130, 132, 134, 136 can either operate as a charging space or a parking space. In one example, vehicle V1 is located in space 130. Vehicle V1 is an electric vehicle, plugs into charging outlet 142 at charging post 112 and requests a charge using a user interface phone application. The user interface communicates with master charging station 110 to perform a charging operation on vehicle V1. The cost of the charging operation is charged to the vehicle driver, using the user interface application. Alternatively, the charging operation can be activated locally at master charging station 110. The master charging station 110 can also act as a pay station, and may accept a credit card or inserted money (e.g., a $20 charge).

Once charging is complete, the driver can either move vehicle V1 to another location or stay parked at space 130. If the driver chooses to stay parked at space 130, the driver is charged a parking rate for parking at space 130. The driver reserves the parking space 130 using the same user interface as the charging user interface (e.g., user interface 120), or the driver can reserve the space 130 for parking using the master charging station 110.

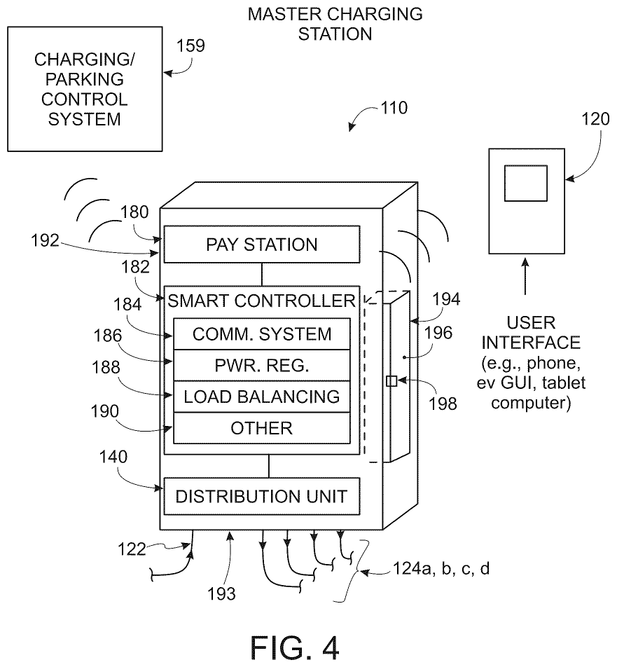

FIG. 4 is a diagram illustrating a master charging station, according to examples of the present disclosure. The master charging station 110 is illustrated as an example and includes one or more components for performing charging operations at charging posts located near charging/parking spaces. In one example, the master charging system 110 includes a pay station 180, a smart controller 182, and power distribution unit 140. The pay station 180 allows the master charging station to operate as a pay station for both charging and parking at a location near the charging posts and parking spaces. In one or more examples, the pay station 180 includes a touch screen for allowing user defined inputs for charging their vehicle, and a mechanism for accepting payment such as credit card payment via a physical card or digital card (e.g., a digital card located on a user phone).

The smart controller 182 aids in operation of the pay station 180 and the power distribution unit 140. In one example, the smart controller includes a communication system 184, a power regulation system 186, load balancing system 188, and other systems 190. The communication system 184 aids in communication between the master charging station 110 and external devices including charging/parking control system 159 and user interface 120, and other systems and devices. The communication system 184 further aids in external communication with pay station 180 and smart controller 182. The power regulation system 186 aids in controlling power regulation between the power distribution feeds to the charging posts, and other charging components and devices. In one example, the power regulation system 186 aids in converting a power feed from AC to DC, or aids in converting an AC to AC or DC to DC voltage level to a desired target charging voltage level. In one example, the master charging station 110 provides for dynamic charging of vehicles. Load balancing can be utilized where the charging load is actively checked and balanced for optimal use of charging capacity and optimal charging of one or more electric vehicles. In one example, load balancing system 188 operates to control load balancing at the power distribution feeds 124a,b,c,d based on desired user inputs. Further, the smart controller 182 is operable to aid in controlling the operation of other devices 190 used as part of charging system 100. One example of load balancing using the present charging system is detailed later in this specification.

In one example, the master charging station 110 includes a housing 192. The housing 192 includes component spaces, and power routing spaces for the charging power feed 122 and the distribution feeds, such as distribution feeds 124a,b,c,d. In one example, the charging power feed and distribution feeds enter and exit the housing 192 at housing bottom 193.

The housing 192 includes a cable storage locker 194. The cable storage locker 194 provides storage space for storing charging cables when not in use. The cable storage locker 194 includes a lockable door 196 for accessing the storage locker 194. In one example, the cable storage locker 194 includes door lock device 198. In operation, upon activation of a charging operation using master charging station 110, smart controller 182 operates to unlock door lock device 198 for user access to a charging cable. Upon completion of a charging operation, the charging cable is returned to the storage locker 194 and the lockable door 196 is again locked via the door lock device 198. The storage locker 194 may also include a cable return detection device. If the cable return detection device does not detect a returned cable after a charging operation is complete, a user can be automatically charged for not returning the charging cable.

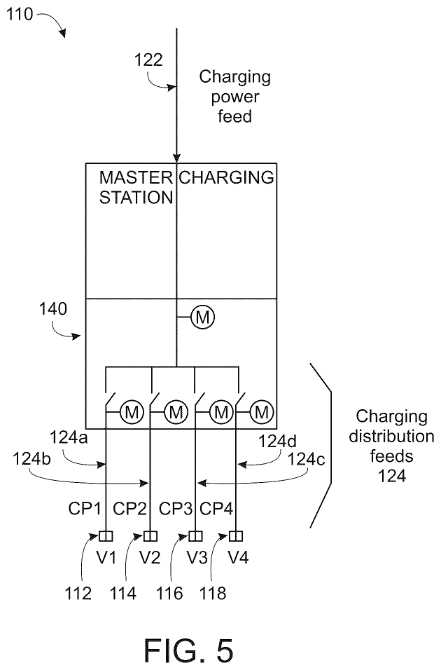

FIG. 5 is a diagram illustrating power flow through a master charging station, including a distribution unit, according to examples of the present disclosure. The master charging station 110 includes an input charging power feed 122. The input charging power feed 122 can be a utility power feed or be a power feed from a larger charging power system. The charging power feed 122 enters master charging station 122 and is routed to power distribution unit 140. The charging power feed 122 can be metered and controlled as part of the master charging station 110 using smart controller 182. In one example, the charging power feed is switchable and controllable using power semiconductor switching devices.

The power distribution unit 140 operates to distribute power to requested charging locations (i.e., charging posts at requested charging locations) via charging distribution feeds 124. The charging distribution feeds 124 (illustrated as 124 a,b,c,d) are separately switchable and separately metered, being controlled by master charging station 110. In one example illustrated, the distribution unit 140 operates to distribute power to request charging locations via charging distribution feeds 124a,b,c,d routed and electrically connected to corresponding charging posts 112, 114, 116, 118.

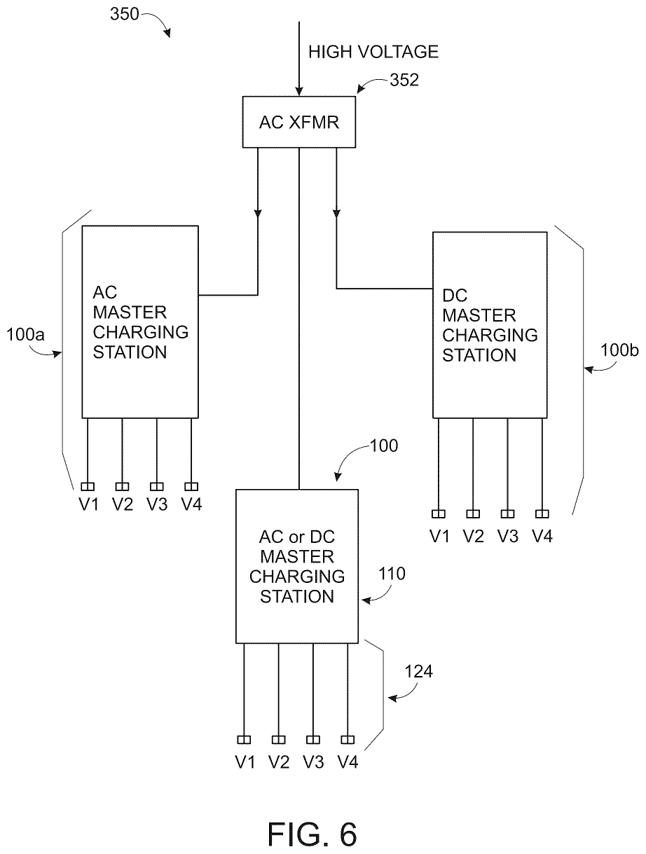

FIG. 6 is a diagram illustrating a power feed system for a large scale charging system that includes multiple charging stations, according to examples of the present disclosure. The charging system is generally illustrated at 350. The charging system 350 includes charging system 100 with power distribution feeds 124 to charging post locations as previously described herein. The charging system 350 further includes charging system 100a and charging system 100b. The charging systems 100a,b are similar to charging system 100 previously detailed herein, and provide for controlled charging and/or parking of vehicles located near charging posts. In one example, a utility high voltage feed is received at transformer 352, and routed to respective charging systems 100, 100a and 100b.

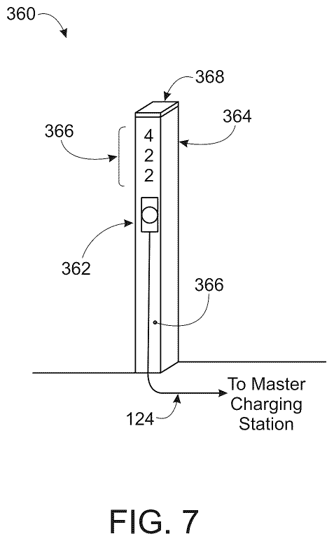

FIG. 7 is a diagram illustrating a charging post suitable for use with a charging system, according to examples of the present disclosure. The charging post is illustrated generally at 360. The charging post 360 is suitable for use in charging systems 100,200,300, and as charging posts 112, 114, 116, 118 previously illustrated herein.

The charging post 360 includes a charging outlet 362. The charging outlet 362 can be mounted internal to the charging post 360 or external to the charging post 360. In one example, charging post 360 includes a housing 364. The charging outlet 362 is mounted to housing 364. The charging post 360 includes an internal cable routing space 366. The distribution feed 124 received from a master charging station is routed through the housing 364 internal routing space 366 and electrically connected to charging outlet 362. The charging outlet 362 is configured to receive an electric vehicle charging cable. In one example, an electric vehicle charging cable is plugged into the charging outlet during a charging operation. In one example, the charging cable is electromagnetically plugged into the charging outlet 362.

The charging post 360 can also include a post number 366 (e.g., post identifier 422), unique identifier or other indicia to identify the charging post desired to perform a charging operation, and/or simply to identify the location of a charging space. A global location device 368 can be positioned on the post 360. The global location device 368 can operate to provide a location of the charging post 360 to a master charging station or larger charging system. In one example, each charging post is numbered and/or addressable as part of an addressable system.

Alternatively, the charging system simply uses the post identifier to locate the charging post based on the system stored location coordinates for the post.

The unique charging posts can be circular, square, triangular, or otherwise shaped. The have a simple design with limited charging components, since most of the active charging components are located at the master charging station. The cross-section of each charging post can be small and in a range of 2-4 inches. Based on the application, the charging post may include a post base that aids in feeding a distribution cable into the post. In most applications, a post base is not necessary. If a post base is used, the post base is not readily accessible from the outside.

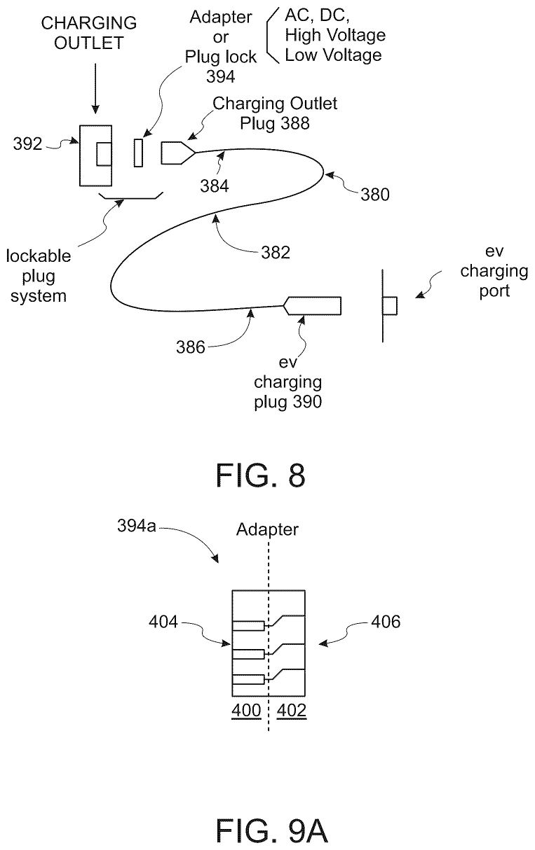

FIG. 8 is a diagram illustrating a charging system charging cable generally at 380, according to examples of the present disclosure. The charging cable 380 is suitable for use within charging systems detailed herein. The charging cable 380 can include a plug at each end. By having a plug at each end, the charging cable is removable, portable, and not susceptible to being stolen by thieves.

In one example, the charging cable 380 includes a cable 382 having a first end 384 and a second end 386. A charging outlet plug 388 is located at first end 384. An ev charging plug 390 is located at second end 386. The charging outlet plug 388 is configured to couple to a charging outlet 392. Charging outlet 392 is a charging post charging outlet that is part of a charging post or coupled to a charging post (e.g., charging outlets 142, 144, 146, 148). In one example, the charging outlet plug 388 quick couples to the charging outlet 392.

In one example, the charging outlet 388 is part of a lockable plug system when mated with the charging outlet 392. One or more examples of a lockable outlet plug system including lockable charging outlet plug and lockable charging outlet are detailed in this specification. Additionally, a plug adapter 394 can be located between the charging outlet plug 388 and the charging outlet 392. In one example, the plug adapter 394 is a plug lock device configured to aid in locking a plug into the charging outlet. In another example, the plug adapter 394 is an adapter device configured to aid in adapting the charging outlet plug to a specific charging outlet configuration.

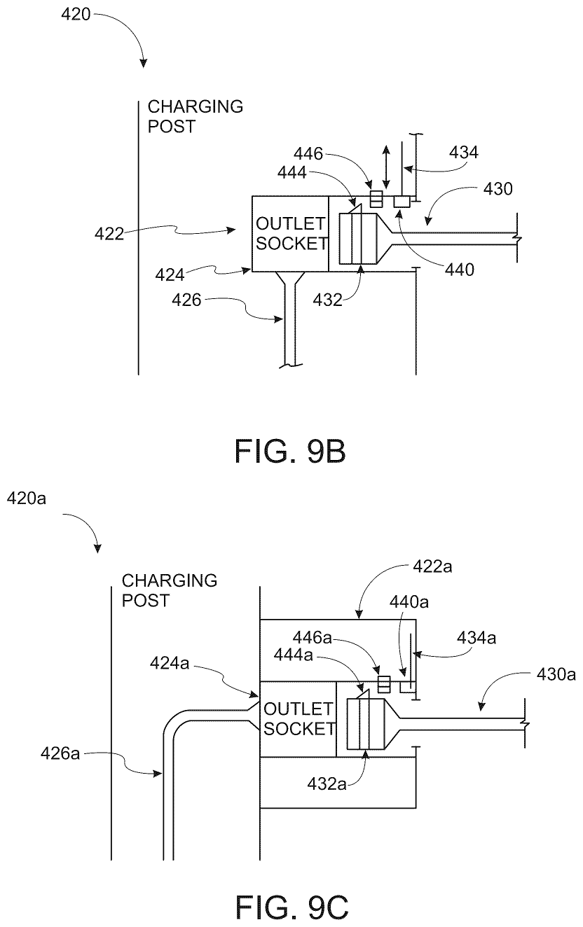

FIG. 9A is a diagram illustrating an adapter 394a for use with a charging cable, according to examples of the present disclosure. The plug adapter 394a is one example of plug adapter 394 illustrated in FIG. 8. The adapter 394a is an adapter device configured to aid in adapting a charging outlet plug to mate with a specific charging outlet configuration. The adapter 394a includes a charging outlet side 400 and a charging outlet plug side 402. The charging outlet side 400 includes charging pin sockets 404 arranged in a configuration to mate with the charging pins of charging outlet 392. The charging outlet plug side 402 includes charging pins 406. The charging pins 406 are arranged in a configuration to mate with the charging outlet plug 388 pin sockets. Internally, the charging pin sockets 404 are mapped to the charging pins 406, with corresponding sockets 404 electrically coupled to corresponding pins 406.

FIGS. 9B, 9C are diagrams illustrating a charging post including a charging outlet, according to examples of the present disclosure.

FIG. 9B illustrates one example of a charging post 420 suitable for use with the present charging systems detailed herein. The charging post 420 includes a changing outlet 422 located inside of the charging post 420. Access to the charging outlet 420 is available through an opening in the charging post housing. The charging outlet includes an outlet socket 424. A charging distribution feed 426 is routed through the charging post 420 and electrically coupled to the outlet socket.

The charging outlet 422 provides a charging cable locking device of locking the charging cable to the charging post 420 during a charging operation. In one example, the charging outlet 422 includes a door 434 for locking a charging cable 430 in the charging outlet 422. A latch 440 operates to lock the door 434 in a desired cable lock position. In one example, the latch is a magnetic latch. The door is moved to narrow the opening about the cable 430, where the plug 432 is unable to be removed from the charging outlet 422. Upon completion of a charging operation, the latch 440 can be either automatically released using the master charging station or released by the user via the user interface. In one example, the latch 440 is a magnetic latch. By releasing the latch 440, the door 434 returns to an open position. In one example, the door 434 is spring loaded, enabling the door 434 to return to an open position.

In one example, the plug 432 includes a locking mechanism or locking tang 444. When inserted into the outlet 422, the plug 432 is maintained and locked into the charging outlet 422. Tang 444 interacts with and is maintained against the outlet lock mechanism 446 to lock the plug 432 in the outlet 422. In a similar manner, upon completion of a charging operation, the outlet lock mechanism is released and plug 432 can be removed. In one example, the outlet lock mechanism 446 is a magnetic locking mechanism that can be released via a master control system or user interface.

In another example, the charging plug 432 can be electromagnetically maintained within the charging outlet 422. Outlet socket 422 is an electromagnetic socket. The plug 422 is a magnetic plug or includes magnetic couplers. Outlet socket 422 is electromagnetically operated to maintain and lock the plug 432 within outlet 422. Upon completion of a charging operation or desired release of the plug 432 from outlet 422, the electromagnetic socket can be switched to release the plug 422. In one example, current flow to the electromagnetic socket is reversed, which results in the charging plug 432 being dynamically released or moved away from outlet socket 424.

FIG. 9C illustrates one example of a charging post 420a suitable for use with the present charging systems detailed herein. The charging post 420a includes a changing outlet 422a located outside of the housing of charging post 420a. Access to the charging outlet 420a is available through an opening in the charging post outlet 422a. The charging outlet 422a includes an outlet socket 424a. A charging distribution feed 426a is routed through the charging post 420a and electrically coupled to the outlet socket 422a.

The charging outlet 422a provides a charging cable locking device of locking the charging cable to the charging post 420a during a charging operation. In one example, the charging outlet 422a includes a door 434a for locking a charging cable 430a in the charging outlet 422a. A latch 440a operates to lock the door 434a in a desired cable lock position. In one example, the latch is a magnetic latch. The door is moved to narrow the opening about the cable 430a, where the plug 432a is unable to be removed from the charging outlet 422a. Upon completion of a charging operation, the latch 440a can be either automatically released using the master charging station or released by the user via the user interface. In one example, the latch 440a is a magnetic latch. By releasing the latch 440a, the door 434a returns to an open position. In one example, the door 434a is spring loaded, enabling the door 434a to return to an open position.

In one example, the plug 432a includes a locking mechanism or locking tang 444a. When inserted into the outlet 422a, the plug 432a is maintained and locked into the charging outlet 422a. Tang 444a interacts with and is maintained against the outlet lock mechanism 446a to lock the plug 432a in the outlet 422a. In a similar manner, upon completion of a charging operation, the outlet lock mechanism is released and plug 432a can be removed. In one example, the outlet lock mechanism 446a is a magnetic locking mechanism that can be released via a master control system or user interface.

In another example, the charging plug 432a can be electromagnetically maintained within the charging outlet 422a. Outlet socket 422a is an electromagnetic socket. The plug 422a is a magnetic plug or includes magnetic couplers. Outlet socket 422a is electromagnetically operated to maintain and lock the plug 432a within outlet 422a. Upon completion of a charging operation or desired release of the plug 432a from outlet 422a, the electromagnetic socket can be switched to release the plug 422a. In one example, current flow to the electromagnetic socket is reversed, which results in the charging plug 432a being dynamically released or moved away from outlet socket 424.

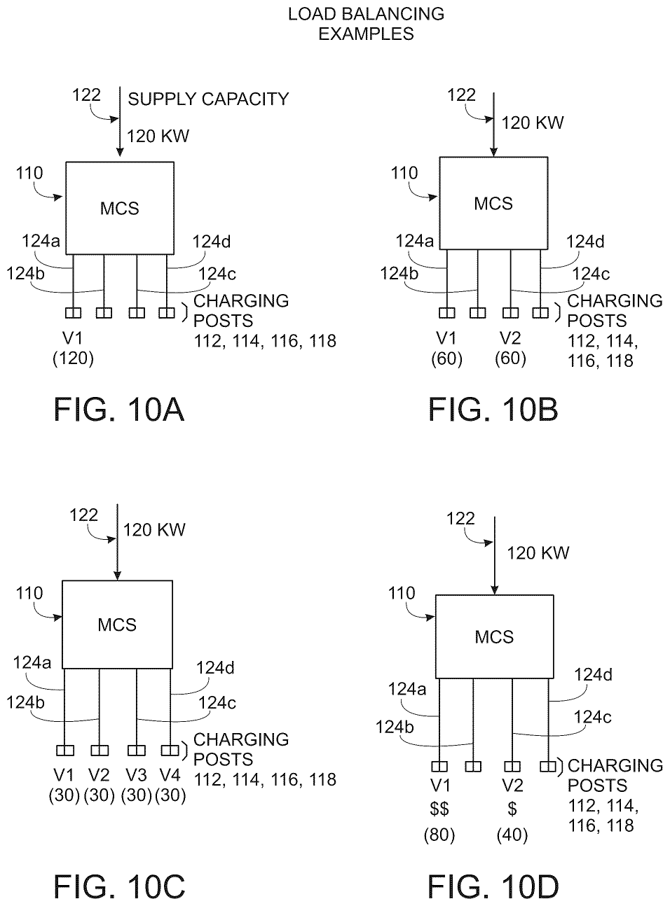

FIGS. 10A-10D are diagrams illustrating a charging system with distributed charging load balancing examples, according to examples of the present disclosure. Master charging station 110 will be used in these load balancing examples.

In FIG. 10A, example charging power feed 122 supply capacity is 120 KW. Only one vehicle V1 is requesting a charge. The entire supply capacity of 120 KW is available for charging vehicle V1 on distribution feeder 124a.

In FIG. 10B, example charging power feed 122 supply capacity is 120 KW. Two vehicles V1 and V2 are requesting a charge. The entire supply capacity of 120 KW is available for charging vehicles V1 and V2. With load balancing, a 60 KW power supply is provided on distribution feeder 124a for charging vehicle V1, and a 60 KW power supply is provided on distribution feeder 124c for charging vehicle V2.

In FIG. 10C, example charging power feed 122 supply capacity is 120 KW. Four vehicles V1, v2, V3 and V4 are requesting a charge. The entire supply capacity of 120 KW is available for charging vehicles V1, V2, V3, V4. With load balancing by master charging station 110, the entire power supply of 120 KW is split up between the power distribution feeds to the vehicles requesting a charge. A 30 KW power supply is provided on distribution feeder 124a for charging vehicle V1, a 30 KW power supply is provided on distribution feeder 124b for charging vehicle V2, a 30 KW power supply is provided on distribution feeder 124c for charging vehicle V3, a 30 KW power supply is provided on distribution feeder 124d for charging vehicle V4. Upon completion of charging one or more of the vehicles, the charging supply feed is dynamically balanced (i.e., adjusted) between the remaining vehicles that haven't completed their charging operation.

In FIG. 10D, example charging power feed 122 supply capacity is 120 KW. Two vehicles V1 and V2 are requesting a charge. The entire supply capacity of 120 KW is available for charging vehicles V1 and V2. Vehicle V1 is willing to pay an additional fee to receive a larger power supply for faster charging. With this load balancing, an 80 KW power supply is provided on distribution feeder 124a for charging vehicle V1, and a 40 KW power supply is provided on distribution feeder 124c for charging vehicle V2. Once charging of vehicle V1 is complete, the charging system dynamically adjusts the charging power supply, and all of the 120 KW power charging capacity is available on distribution feed 124c for charging of vehicle V2.

It is recognized that the parking/charging system of the present disclosure can be configured for use in many charging system applications, including those not disclosed herein.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

The claims are part of the specification.

1. A vehicle charging system with distributed charging comprising:
a master charging station having a power distribution unit including a first charging distribution feed;
a first charging post located separate from the master charging station, the first charging post including a first charging outlet coupled to the first charging distribution feed for charge connecting to an electric vehicle; and
a user interface that controls the flow of charging power between the master charging station and the first charging outlet.

2. The system of claim 1, comprising:
the master charging station including a smart system that communicates with the user interface to regulate power flow between the master charging station and the first charging post.

3. The system of claim 1, comprising:
the master charging station including a charging cable port.

4. The system of claim 3, the charging cable port including an access door, where the access door includes a locked position and an unlocked position.

5. The system of claim 4, where the smart system moves the access door between the locked position and the unlocked position.

6. The system of claim 3, comprising a charging cable positioned within the charging cable port.

7. The system of claim 1, where the first charging post includes a unique identifier that aids in identifying the location of the charging post.

8. The system of claim 7, where the unique identifier that aids in identifying the location of the charging post is a GPS identifier.

9. The system of claim 1, the first charging outlet including a locking mechanism configured to lock a charging cable to the charging post during a charging operation.

10. The system of claim 1, the first charging post including a charging post port configured to store a charging cable.

11. The system of claim 1, comprising a charging cable including a post plug, where the post plug is coupled to the first charging outlet.

12. A vehicle charging system with distributed charging comprising:
a master charging station including having an input charging power feed and a distribution unit, where the distribution unit receives the input charging power feed and provides multiple charging distribution feed outputs, including a first charging distribution feed and a second charging distribution feed;
a first charging post spaced from the master charging station and coupled to the first charging distribution feed, the first charging post including a first charging outlet coupled to the charging distribution feed; and
a second charging post spaced from the master charging station and coupled to the second charging distribution feed, the second charging post including a second charging outlet coupled to the second charging distribution feed.

13. The vehicle charging system of claim 12, comprising:
a user interface that controls the flow of charging power between the master charging station and the first charging outlet and the second charging outlet to charge one or more electric vehicles.

14. The vehicle charging system of claim 12, comprising:
a charging power metering system, where charging power output to the first charging distribution feed and the second charging distribution feed is separately metered via the charging power metering system.

15. The vehicle charging system of claim 12, where the first charging distribution feed includes a first feed power switch, and the second charging distribution feed includes a second feed power switch.

16. The vehicle charging system of claim 15, the master charging station including a smart controller that controls power flow through the first feed power switch and the second feed power switch.

17. The vehicle charging system of claim 12, where
the master charging station comprises a pay station; and a smart controller including a communication system configured to communicate with one or more external systems and a load balancing system.

18. The vehicle charging system of claim 17, where the pay station is configured to charge a first user having a vehicle charging at the first charging post at a first rate, and configured to charge a second user having a second vehicle parked at the second charging post at a second rate, where the second rate is different than the first rate.

19. The vehicle charging system of claim 12, the first charging post including a first smart identifier that aids in identifying a first location of the first charging post, and a second smart identifier that aids in identifying a second location of the second charging post.tation.

20. A method of charging a vehicle using the vehicle charging system of claim 1.
